(19) United States
(12) Patent Application Publication
(10) Pub. No.: US 2025/0026001 A1
(43) Pub. Date: Jan. 23, 2025

(54) WEARABLE AID WITH ARTICULATED LINKING OF THE UPPER BODY LINKING MEANS

(71) Applicant: J.SCHMALZ GMBH, Glatten (DE)

(72) Inventors: Oliver EBERHARDT, Freudenstadt (DE); Christina HARBAUER-RIESS, Muenchen (DE)

(21) Appl. No.: 18/715,665

(22) PCT Filed: Jun. 1, 2022
(86) PCT No.: PCT/EP2022/064981

§ 371 Date: May 31, 2024

(30) Foreign Application Priority Data
Jan. 5, 2022 (DE) 10 2022 100 204.7

(51) Int. Cl. B25J 9/00

(52) U.S. Cl. CPC B25J 9/0006

(57) ABSTRACT

The invention relates to a wearable aid (10) for supporting in the raising and/or holding of loads by an operator, comprising a supporting structure (16) having a first support (22-1) and a second support (22-2), wherein the first support and the second support each have a rear section (24-1, 24-2) and a cantilever-type section (26-2, 26-2), a lower body linking means (18) for coupling the supporting structure to a pelvic, hip or lumbar area of the operator, an upper body linking means (20) for coupling the supporting structure to an upper body of the operator, a first hand linking means (40-1) and a second hand linking means (40-2), each for linking to a hand or underarm region of the operator, wherein the first support is connected to the lower body linking means via a first lower joint device (106-1) at a first lower connection point (32-1), and wherein the second support (22-2) is connected to the lower body linking means via a second lower joint device (106-2) at a second lower connection point (32-2).

### FIELD

The invention relates to a wearable aid for supporting the raising and/or holding of loads by an operator.

### BACKGROUND

Aids can be used to transfer the loads acting on the user when raising objects either directly to the floor or at least only through selected areas of the body, e.g., an operator's hip area, and thus relieve the user's joint and muscle system.

It is known to design aids as stationary or partially mobile devices which are installed, for example, at a user's workstation. For example, stationary lifting aids such as tube lifters, rope balancers or manipulators are described in the prior art, by means of which unit loads can be picked up and moved from one position to another. However, such aids are limited in their flexibility, as they cannot easily be moved to a new location and made ready for use there.

Aids are also known which are designed as completely mobile devices that can be put on by the user. Such mobile aids usually have one or more body linking means via which the aid can be coupled to the body of an operator and via which forces can be transmitted between the aid and the body.

For example, so-called exoskeletons are known, which can be used as lifting aids for raising loads. Designs are known in which the exoskeleton substantially replicates the entire kinematic chain for the lifting process, i.e., the load-bearing limbs and degrees of freedom of movement of the wearer (“joints” of the exoskeleton) are replicated as accurately as possible by the exoskeleton. Such solutions are also known as anthropomorphic exoskeletons. However, such exoskeletons have the disadvantage that, for reasons of complexity, not all degrees of freedom of the human body are usually represented, resulting in movement restrictions and thus reduced ease of use. In addition, such exoskeletons are often heavy and therefore unwieldy.

WO 2014/195373 A1 also discloses a non-anthropomorphic lifting aid which has support elements that can move relative to one another and multiple body linking means points that are rigidly connected to the support elements.

The known aids are generally only adaptable to the specific anatomical conditions of a user to a limited extent, which can have a negative effect on the transmission of force between the body and the aid. In addition, freedom of movement for the operator and therefore comfort for the user is regularly restricted with the known aids.

### SUMMARY

The invention addresses the problem of providing an aid which effectively relieves a user when handling an object and also enables a high degree of freedom of movement. In addition, the aid should be designed to be ergonomic and comfortable for the user to operate.

This problem is solved by an aid with the features of claim 1. The aid is designed as a wearable aid to support the raising and/or holding of loads by an operator, in the sense of a device that can be worn by a person on the body to support the raising and/or holding of objects (“body-worn lifting aid”). In other words, the aid is designed in particular in such a way that it can be worn by a person and the person can move to another location with the aid worn. In particular, the device can be designed in such a way that it can be put on by the operator like a backpack.

The aid comprises a supporting structure which is designed to absorb a weight force and/or inertial force of a load and to redirect this force to certain areas of the operator's body.

The supporting structure comprises a first (right-hand) support and a second (left-hand) support separate from the first support. The first and second supports each have a back section and a cantilever-type section. The supports are designed in such a way that, when the aid is worn by the operator, the back section is arranged posteriorly, i.e., dorsally or “at the rear” of the body, and extends substantially starting from the hip cranially along the back section of the operator or extends starting from the hip cranially along the back section of the operator. This does not mean that the back section must run exactly in parallel with the operator's back. The cantilever-type section is designed in such a way that it extends from posterior to anterior, i.e., ventrally or “from the back to the front of the body,” when the aid is worn. When the operator is standing upright, the back section in particular extends substantially vertically and the cantilever-type section at least partially horizontally. In this respect, the back section can form a vertical support and the cantilever-type section can form a horizontal support. The back section and/or the cantilever-type section can be straight along its longitudinal extent or have a curvature along its longitudinal extent, at least in sections. In particular, the cantilever-type section can be connected to the back section. Preferably, the relevant cantilever-type section extends over one shoulder of the operator when the aid is worn. The back section and the cantilever-type section can be formed in one piece or separately from each other. In particular, the back section can be movably connected to the cantilever-type section, for example pivotable about a first and/or second cantilever pivot axis (see below). The back section and the cantilever-type section are particularly dimensionally stable. For example, it is conceivable that the supports are formed from pipe sections and/or cut-to-length profile parts. In order to be able to adapt the aid to different body sizes, in particular back lengths, it can be advantageous if the back section of a relevant support itself is designed to be length-adjustable. It is also conceivable that the cantilever-type section is designed to be adjustable in length.

The aid also comprises an upper body linking means, in particular a top body linking means, for coupling the supporting structure to an upper body of the operator. In particular, the upper body linking means can be designed to couple the supporting structure to a back, shoulder and/or chest area of the operator.

The aid also comprises a lower body linking means, in particular a hip linking means, for coupling the supporting structure to a pelvic, hip and/or lumbar area of the operator. For example, the lower body linking means can have a hip belt connected to the supports, which surrounds the operator's hips and can be secured to them. In particular, the lower body linking means is not designed to couple the supporting structure to the lower extremities of the operator, such as a thigh, knee or lower leg.

The upper body linking means and the lower body linking means are designed in such a way that forces can be transmitted between the body and the supporting structure. In particular, the upper body linking means can be designed to introduce such forces into the body that result from the dead weight of the supporting structure, the support reactions required for static equilibrium and the guiding forces of the support sections. In particular, the lower body linking means can be designed to transfer the forces and moments resulting from the handling of a load into the body. In particular, the upper and/or the lower body linking means are designed to secure the supporting structure to an area of the operator's body and thus hold the aid on the operator's body. In this respect, the upper and/or the lower body linking means are designed in particular in such a way that the aid can be “worn” by the operator by coupling the supporting structure to the body by means of the upper or lower body linking means. The upper and/or lower body linking means can be detachably connected to the supporting structure, in particular it can be repeatedly connected and disconnected again. Preferably, the upper body linking means and the lower body linking means are arranged at a distance from each other and are force-coupled to each other, in particular exclusively, via the supporting structure. This has the advantage that no vertical forces or only a small proportion of the vertical forces resulting directly from a load being held are transferred to the user's upper body.

The aid also comprises a first (right) hand linking means for linking to a right hand or underarm area of the operator, for example to a wrist and/or a carpus of the operator. The first hand linking means is connected to the first support, in particular to a free end of the cantilever-type section of the first support, via a first length-adjustable connecting device.

The aid also comprises a second (left) hand linking means for linking to a left hand or underarm area of the operator, for example a wrist and/or a carpus of the operator. The second hand linking means is connected to the second support, in particular to a free end of the cantilever-type section of the second support, via a second length-adjustable connecting device. In this respect, the hand linking means serve as a link between the human hand and the aid.

The weight and inertia forces of the load being held can be transferred to the supporting structure via the hand linking means and the connecting devices and then transferred to selected areas of the operator's body via the body linking means. With the proposed aid, the support starts in particular from the wrist of the operator. Preferably, the hand attachments are designed in such a way that the human hand itself is used to grip the object to be lifted, which is superior to technical gripping systems in terms of its versatility. For this purpose, the hand linking means can be designed in various ways. For example, a design as a sleeve that surrounds the carpus and possibly also the wrist of the hand is conceivable.

The length-adjustable connecting devices can be designed in particular as a cable pull. In this respect, the first hand linking means can be connected to the first support via a first cable pull and the second hand linking means can be connected to the second support via a second cable pull. In particular, a common or relevant drive device can be provided to drive the cable pulls. In this way, active support for the operator can be achieved, e.g., during a lifting operation or when holding a load statically. In particular, the at least one drive unit can be mounted on the supporting structure. In particular, the cables of the cable pulls can each be guided via a cable guide, preferably running inside the relevant support, and exit the support, in particular the cantilever-type section, via a cable deflection device.

In the proposed aid, the first and second supports are each articulated to the upper body linking means. Specifically, the first support, in particular the back section of the first support, is connected to the upper body linking means at a first upper connection point via a first upper joint device and the second support, in particular the back section of the second support, is connected to the upper body linking means at a second upper connection point via a second upper joint device.

Such an aid makes it possible to effectively relieve an operator when handling objects, but without excessively restricting the operator's freedom of movement. In particular, the articulated connection of the supports to the upper body linking means enables a relative movement of the supporting structure and the upper body linking means, so that the supporting structure can follow the upper body movement of the operator at least to a certain extent. For example, it is conceivable that the articulated connection can compensate for rotational movements of the upper body in the aid, which significantly increases freedom of action when handling objects. The operator can therefore carry out a work activity with largely natural movement patterns despite the aid being worn.

Increased freedom of movement is achieved in particular if the first upper joint device and the second upper joint device each have at least two, preferably at least three, degrees of joint freedom. In this respect, the upper joint devices are designed in particular in such a way that the supports can be moved along at least two, preferably along at least three, degrees of freedom relative to the upper body linking means.

In an advantageous embodiment, the upper joint devices can each have a first degree of freedom of pivot about a first pivot axis. In particular, the first pivot axis can be oriented orthogonally to the median plane when the aid is worn. In the present context, the median plane—as is common in anatomy—refers to a body plane, particularly a vertical one, which extends from the front body wall to the rear body wall and divides the body symmetrically into a right and a left half. This degree of pivoting freedom allows the operator to bend their torso and at the same time helps to compensate for asymmetrical body movements. In addition, the first degree of pivoting freedom favors rotation of the upper body relative to the hips. The first degree of pivoting freedom can be provided in particular by a first pivot joint, which is connected to the upper body linking means, in particular an upper main body of the body linking means.

The upper joint devices can also each comprise a second degree of pivoting freedom about a second pivot axis orthogonal to the first pivot axis. When the aid is worn, the second pivot axis can then in particular be oriented orthogonally to the frontal plane. In the following context, the frontal plane—as is common in anatomy—refers to a body plane, particularly a vertical one, which divides the body into a front and a rear part. The second degree of pivoting freedom also makes it possible to simulate asymmetrical body movements, such as those that occur when lifting and/or carrying with just one hand. In addition, the second degree of pivoting freedom favors an undisturbed lateral tilt and/or rotation of the upper body relative to the hips. The second degree of pivoting freedom can be provided in particular by a second pivot joint, which is connected to the first pivot joint.

The upper joint devices can also each comprise a translational degree of freedom, in particular along a longitudinal axis of the relevant support, further in particular along a longitudinal axis of the back section of the relevant support. In this respect, the upper joint devices can be designed in particular in such a way that the supports are mounted on the upper body linking means so that they can be moved axially along their longitudinal axis. The translational degree of freedom in particular allows the upper body linking means to be decoupled from the lower body linking means. This can prevent vertical forces resulting from the lifted loads from being transferred to the upper body, in particular to the operator's shoulders. In addition, the translational degree of freedom can be used to simulate opposing hip movements when walking and/or back extension during trunk flexion in the aid.

The translational degree of freedom can be provided in particular by a sliding sleeve in which the relevant support, in particular with its back section, is axially displaceable along the longitudinal axis of the support. It is also conceivable that the translational degree of freedom is formed in the relevant support itself, in particular in the back section.

In particular, the sliding sleeve can be designed in such a way that the support is mounted in the sliding sleeve so that it can pivot about its longitudinal axis, i.e., about the sliding axis. Such a design increases the user's freedom of movement, especially when the hips and chest twist against each other when walking or during a back rotation. In addition, such a design makes it possible, for example, to move the arms in an outstretched position and to the left or right in the frontal plane. Preferably, the relevant sliding sleeve is designed in such a way that a maximum pivot angle is limited in such a way that the extension arm section cannot be pivoted against a body area, in particular against the head, of the operator.

In an advantageous embodiment, the upper body linking means can comprise an upper force distribution device, which is connected to the supports, in particular to the back section of the supports, via the upper joint devices. The upper body linking means can also comprise a flexible upper body linking means device connected to the upper force distribution device, in particular one that can be adapted to the anatomy of the operator, for linking to an upper body area of the operator. The upper force distribution device is designed in particular to absorb forces from the supports and redirect them to the upper body linking means device, which then transfers the forces to the operator's body.

The upper body linking means device can in particular comprise, in particular consist of, at least one textile part. The at least one textile wedge can be in the form of a belt or a cuff, for example. It is conceivable, for example, that the upper body linking means device comprises a belt system. Advantageously, the belt system can be designed in such a way that the aid can be worn by the operator like a backpack.

A particularly stable design can be that the upper force distribution device has an upper main body which extends between the first support and the second support, in particular between the back section of the first support and the back section of the second support. The upper joint devices can then be arranged on the upper main body. In this respect, the upper main body serves as the upper connecting link between the first and second support. However, the upper main body can also be constructed in one or more parts.

As part of an advantageous further development, the upper force distribution device can also comprise a force introduction plate to support the introduction of horizontal forces into a back area of the operator. In particular, the force introduction plate is arranged on the upper body linking means in such a way that the force introduction plate is aligned in parallel with a back surface of the operator, in particular in the middle of the back, when the aid is worn. Preferably, the force introduction plate is connected to the upper main body in such a way that a distance between the force introduction plate and the upper main body and thus a distance between the main body and the back can be changed, in particular adjusted. The force introduction plate can also be connected to the upper body linking means device, for example the belt system described above, in such a way that a position of the force introduction plate can be changed, in particular adjusted, cranially, i.e., in the direction of the operator's head, or caudally, i.e., in the direction of the operator's buttocks. For example, it is conceivable that the position of the force introduction plate can be changed cranially or caudally by changing the length of the belt system described above. Such a design makes it possible to flexibly adapt the position of the force introduction plate to the anatomical conditions of the operator and thus achieve an efficient application of force to the body.

In order to be able to flexibly adapt the upper body linking means to the shape of the operator's back, it can also be advantageous if the upper body linking means is designed in such a way that a relative position of the first upper connection point and the second upper connection point can be changed, in particular adjusted. In particular, the upper body linking means can be designed in such a way that, when the aid is worn by the operator, a position of the first upper connection point and/or the second upper connection point can be changed, in particular can be adjusted, laterally and/or medially relative to the median plane. This makes it possible to adjust the upper body linking means to a back width and thus to set an optimum fit of the aid for the operator. The upper body linking means can also be designed in such a way that, when the aid is worn by the operator, a position of the first upper connection point and/or the second upper connection point can be changed, in particular adjusted, in the anterior (ventral) direction and/or in the posterior (dorsal) direction relative to the frontal plane. This makes it possible to set a distance between the supports and the operator's back.

It is conceivable that the supporting structure is only coupled to the lower body linking means via one of the two supports. For efficient force transmission, however, it is advantageous if the first support is connected to the lower body linking means at a first lower connection point and if the second support is connected to the lower body linking means at a second lower connection point. In an advantageous further development, the first support and the second support can be articulated to the lower body linking means. In particular, the first support can be connected to the lower body linking means at the first lower connection point via a first upper lower joint device and the second support can be connected to the lower body linking means at the second lower connection point via a second lower joint device. In particular, the lower joint devices have at least two, in particular three, degrees of joint freedom. Preferably, the lower joint devices are designed as ball joints. In combination with the articulated linking of the supports to the upper body linking means, such a design further increases the freedom of movement of the operator and also improves the wearing comfort of the aid. In particular, the lower body linking means can be variably adapted to a hip width and/or a corresponding curvature of the hip of the operator.

It can be advantageous for wearing the aid if the degrees of joint freedom of the upper joint devices and/or the optional lower joint devices can be locked and thus the supports can be secured in a predetermined latching position. For this purpose, the aid can comprise a securing device for securing the first and second upper joint devices and/or optionally a securing device for securing the first and second lower joint devices.

A particularly advantageous design of the aid can result if the first support and the second support are each connected to the lower body linking means via a ball joint and if the upper joint devices each have at least two, preferably at least three, degrees of joint freedom. Such a design enables the operator to perform body movements that are as natural as possible during a work process, for example bending the upper body, tilting it to the side and/or twisting it relative to the hips.

For efficient application of force to the body, it can also be advantageous if the aid can also be variably adapted to the body dimensions of an operator in the region of the lower body linking means. For this purpose, the lower body linking means can be designed in such a way that a relative position of the first lower connection point and the second lower connection point, in particular of the first lower joint device and the second lower joint device, can be changed, in particular adjusted. In combination with the articulated linking of the supports to the upper body linking means described above and/or with the optional adjustability of the upper body linking means, different anatomies can thus be represented, e.g. broad shoulders in combination with narrow hips. It can be particularly advantageous if the lower body linking means is designed in such a way that a position of the first lower connection point and/or the second lower connection point can be changed laterally and medially relative to the median plane, i.e., in particular orthogonally to the median plane, when the aid is worn This makes it possible to adapt the lower body linking means to the width of the hips of the operator and/or a corresponding curvature of the hips. Furthermore, it can be advantageous if the lower body linking means is designed such that, when the aid is worn, a position of the first lower connection point and/or the second lower connection point can be changed, in particular adjusted, in the anterior (ventral) direction and in the posterior (dorsal) direction relative to the frontal plane, in particular orthogonally to the frontal plane. This makes it possible to set a distance between the first and/or second lower connection point and the operator's back.

In an advantageous embodiment, the cantilever-type section of the first support can be pivotably connected to the back section of the first support and the cantilever-type section of the second support can be pivotably connected to the back section of the second support. Preferably, the relevant cantilever-type section is arranged on the relevant back section so that it can pivot about a first, in particular vertical, cantilever pivot axis parallel to the longitudinal axis of the back section. This makes it possible to swivel the cantilever-type section to the left or right when the aid is worn, in particular without having to swivel the back section as well. Alternatively or additionally, the relevant cantilever-type section can be arranged on the back section so as to be pivotable about a second cantilever pivot axis that is orthogonal, in particular horizontal, to the longitudinal axis of the back section and to a longitudinal axis of the cantilever-type section. This makes it possible to swivel the cantilever-type section “upward” or “downward,” in particular without having to swivel the back section as well.

### BRIEF DESCRIPTIONS OF THE DRAWINGS

The invention is explained in more detail below with reference to the figures. In the figures:

FIG. 1 shows a simplified schematic representation of an embodiment of an aid;

FIG. 2 shows a simplified schematic representation to explain a state of use of the aid;

FIG. 3 shows a simplified schematic representation of an embodiment of the upper body linking means in a front view;

FIG. 4 shows a sketched representation of an embodiment of the upper body linking means in a rear view;

FIG. 5 shows a simplified schematic representation of a body linking means device of the upper body linking means;

FIG. 6 shows a simplified schematic representation of an embodiment of the upper body linking means in a top view;

FIG. 7 shows a simplified schematic representation of the aid to explain the adjustability.

In the following description and in the figures, identical reference signs are in each case used for identical or corresponding features.

### DETAILED DESCRIPTION

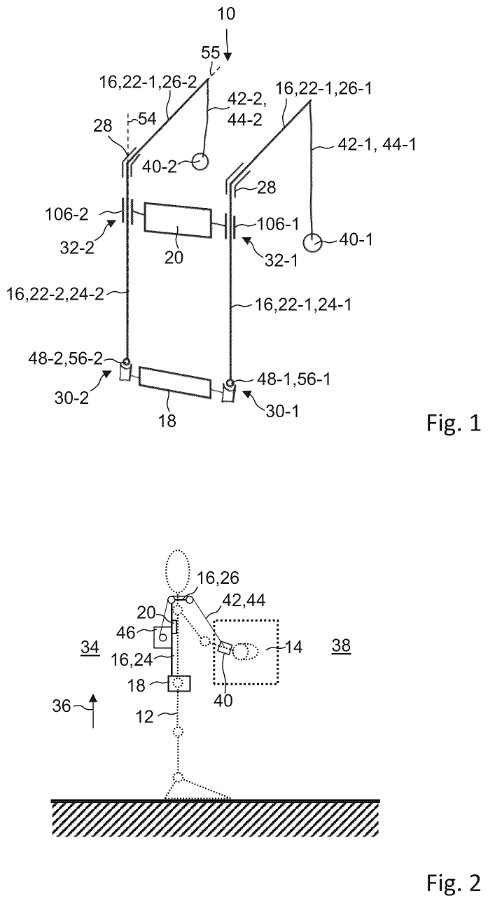

FIG. 1 shows, in a simplified schematic representation, a wearable aid, which is denoted as a whole by reference sign 10. The aid 10 is designed to support an operator 12 when raising and/or holding a load 14 (cf. FIG. 2). As explained in detail below, the aid 10 is designed as a mobile device that can be worn and transported by the operator 12.

The aid 10 comprises a supporting structure 16, which is designed to absorb a load-bearing force, in particular the weight force and/or inertial force of a load 14 held by the operator 12, and to divert it to certain areas of the body of the operator 12. For this purpose, the aid 10 also comprises a lower body linking means 18 for coupling the supporting structure 16 to a pelvic, hip or lumbar area of the operator 12. The lower body linking means can, for example, have a hip belt (not shown) which comprises the hips of the operator 12. The aid 10 also comprises an upper body linking means 20 for coupling the supporting structure 16 to an upper body of the operator 12 (explained in more detail below).

The supporting structure 16 comprises a first (right) support 22-1 and a second (left) support 22-2. As can be seen from FIG. 1, the supports 22-1, 22-2 each comprise a back section 24-1, 24-2 and a cantilever-type section 26-1, 26-2. In the example shown, the back sections 24-1, 24-2 are connected to the cantilever-type sections 26-1, 26-2 via only schematically indicated support connectors 28. It is also conceivable that the back sections 24-1, 24-2 are formed in one piece with the corresponding cantilever-type sections 26-1, 26-2. It is also conceivable that the cantilever-type sections 26-1, 26-2 are pivotably connected to the corresponding back sections 24-1, 24-2 via corresponding cantilever joints (not shown). For example, the cantilever joint can be designed in each case in such a way that the relevant cantilever-type section 26-1, 26-2 can be pivoted about a first, in particular vertical, cantilever pivot axis parallel to the longitudinal axis 54 of the back section 24-1, 24-2 and/or can be pivoted about a second, in particular horizontal, cantilever pivot axis orthogonal to the longitudinal axis 54 of the back section 24-1, 24-2 and to a longitudinal axis 55 of the cantilever-type section 26-1, 26-2.

As shown schematically in FIG. 1, the first support 22-1 is connected to the lower body linking means 18 at a first lower connection point 30-1 and is connected to the upper body linking means 20 at a first upper connection point 32-1. Accordingly, the second support 22-2 is connected to the lower body linking means 18 at a second lower connection point 30-2 and is connected to the upper body linking means 20 at a second upper connection point 32-2 (explained in more detail below).

As can be seen from FIG. 2, the aid 10 is designed in such a way that when the aid 10 is worn by the operator 12, the back sections 24-1, 24-2 are arranged posteriorly, i.e., on a rear side 34 of the operator 12, and extend substantially cranially (cf. arrow 36 in FIG. 2) from the lower body linking means 18 along the back section of the operator 12 (in FIG. 2 by way of example vertically). The cantilever-type sections 26-1, 26-2 are designed such that they extend from posterior to anterior, i.e., from the rear side 34 to a front side 38 of the operator 12, in particular over a shoulder of the operator, when the aid 10 is worn.

In the example shown, the back sections 24-1, 24-2 and the cantilever-type sections 26-1, 26-2 are orthogonal to each other. However, other embodiments are also conceivable in embodiments not shown. For example, it is conceivable that the relevant cantilever-type section 26-1, 26-2 adjoins the back section 24-1, 24-2 and has a curvature such that the cantilever-type section 26-1, 26-2 extends anteriorly to posteriorly when the aid 10 is worn.

The aid 10 further comprises a first hand linking means 40-1 for linking to a right hand or underarm region of the operator 12 and a second hand linking means 40-2 for linking to a left hand or underarm region of the operator 12. As shown schematically in FIG. 1, the first hand linking means 40-1 is connected to the cantilever-type section 26-1 of the first support 22-1 via a first, in particular length-adjustable, connecting device 42-1. The second hand linking means 40-2 is connected to the cantilever-type section 26-2 of the second support 22-2 via a second, in particular length-adjustable, connecting device 42-2. By way of example and preference, the connecting device 42-1, 42-2 can be a driven cable pull 44-1, 44-2. The aid 10 can then also have a common drive device or a separate drive device 46 for each cable pull 44-1, 44-2, which is preferably mounted on the supporting structure 16 (cf. FIG. 2). The aid 10 can then comprise a cable guide (not shown) for each cable pull 44-1, 44-2, in particular integrated in the supports 22, which is designed to guide the cable from the drive device 46 to the hand linking means 40-1, 40-2. In particular, the cable can then exit at a free end of the cantilever-type section 26-1, 26-2 via a cable deflection device (not shown).

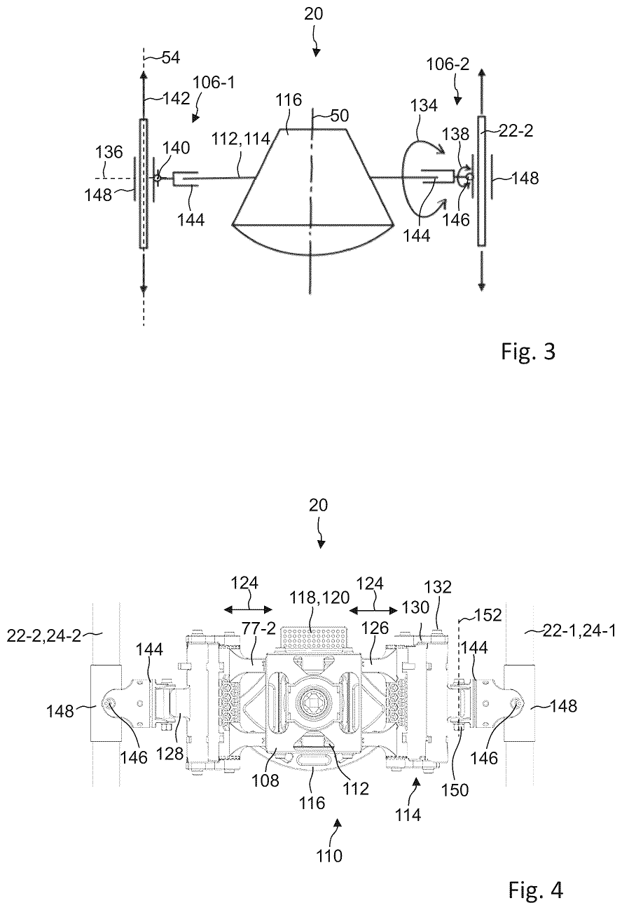

As shown only schematically in FIG. 1, the first support 22-1 is connected to the upper body linking means 20 at the first upper connection point 32-1 via a first upper joint device 106-1 and the second support 22-2 is connected to the upper body linking means 20 at the second upper connection point 32-2 via a second upper joint device 106-2 (described in more detail below with reference to FIG. 3).

Optionally, the first support 22-1 can also be connected to the lower body linking means 18 at the first lower connection point 30-1 via a first lower joint device 48-1, and the second support 22-2 can be connected to the lower body linking means 18 at the second lower connection point 30-2 via a second lower joint device 48-2. In the example shown, the optional lower joint devices 48-1, 48-2 are designed as ball joints 56-1, 56-2.

FIG. 3 shows a simplified schematic representation of an exemplary design of the upper body linking means 20 in a front view. As can be seen from FIG. 3, the upper joint devices 106-1, 106-2 each have three degrees of joint freedom in the example shown. Specifically, the upper joint devices 106-1, 106-2 each comprise a first degree of pivoting freedom (indicated by the arrow 134 in FIG. 3) about a first pivot axis 136. The upper joint devices 106-1, 106-2 also each comprise a second degree of pivoting freedom (indicated by the arrow 138 in FIG. 3) about a second pivot axis 140 orthogonal to the first pivot axis 136. In addition, the upper joint devices 106-1, 106-2 each comprise a translational degree of freedom (indicated by the double arrow 142 in FIG. 3) along a longitudinal axis 54 of the support 22-1, 22-2. When the aid 10 is worn, the first pivot axis 136 is oriented in particular orthogonally to the median plane 50 and the second pivot axis 140 is oriented orthogonally to the frontal plane 52 (cf. FIG. 6, corresponding to the drawing plane in FIG. 3).

In the example shown, the first degree of pivoting freedom 134 is provided by a first pivot joint 144, which is connected to the upper body linking means 20, in particular a main body 108 of the upper body linking means 20, which will be explained in more detail below (cf. also FIG. 6). The second degree of pivot freedom 138 is provided by a second pivot joint 146, which is connected to the first pivot joint 144. The translational degree of freedom is provided by a displacement sleeve 148, which is connected to the second pivot joint 146 and in which the relevant support 22-1, 22-2 is accommodated so as to be displaceable along the longitudinal axis 54. Preferably, the sliding sleeve 148 is designed such that the support 22-1, 22-2 is received in the sliding sleeve 148 such that it can pivot about its longitudinal axis 54. Preferably, the upper body linking means 20 is symmetrical in relation to the median plane 50.

An exemplary embodiment of an upper body linking means described above is shown in FIG. 4, wherein the same reference signs are used for identical or corresponding features. In the example shown, the upper joint devices each additionally comprise an optional third pivot joint 150 about a third pivot axis 152 orthogonal to the first and second pivot axes 136, 140.

In the example shown, the upper body linking means 20 comprises an upper main body 108 which is arranged between the back sections 24-1, 24-2 of the supports 22-1, 22-2. The main body 108 is part of an upper force distribution device 110, which is designed to absorb and redirect forces from the supports 22-1, 22-2. The upper body linking means 20 also comprises a force introduction plate 116, which is also part of the upper force distribution device 110. For example and preferably, the force introduction plate 116 is displaceably mounted on the upper main body 108 in such a way that a distance between the upper main body 108 and the force introduction plate 116 and thus a distance between the upper main body 108 and the back can be changed, in particular adjusted.

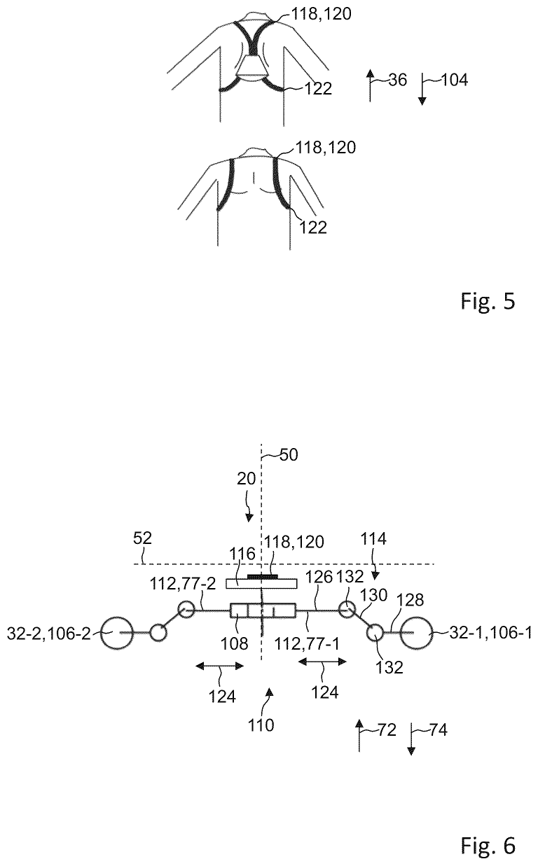

As shown in FIG. 5 as an example, the force introduction plate 116 is connected to a belt system 118, via which the aid 10 can be connected to an upper body of the operator 12. In this respect, the belt system 118 forms an upper body linking means device 120. By way of example and preference, the belt system 118 comprises multiple belts 122, which may preferably be made of textile. As shown in FIG. 5, the belt system 118 can be designed as an example in such a way that the aid 10 can be worn like a backpack. In particular, the force introduction plate 116 may be displaceably connected to the belt system 118 such that a position of the force introduction plate 116 and thus a position of the upper body linking means 20 cranially 36 or caudally 104 may be changed.

The upper body linking means 20 also comprises, in the example shown, an optional first adjustment mechanism 112 which is designed to change a distance between first and second upper joint devices 106-1, 106-2 (indicated by the double arrow 124 in FIG. 6). By way of example, the first upper adjustment mechanism 112 can comprise a left and a right rack device 77-1, 77-2, by means of which the supports 22-1, 22-2 are displaceably held on the main body 108 (cf. FIG. 6), in particular via the joint devices 106-1, 106-2.

In the example shown, the upper body linking means 20 also comprises a second optional upper adjustment mechanism 114, which is designed to change, in particular adjust, a position of the upper joint devices 106-1, 106-2 anteriorly (cf. arrow 72 in FIG. 6) or posteriorly (cf. arrow 74 in FIG. 6) relative to the frontal plane 52. An exemplary embodiment of the second upper adjustment mechanism 114 is only indicated schematically in FIG. 6. By way of example, the second upper adjustment mechanism 114 comprises three segments 126, 128, 130. As can be seen in FIG. 6, the first segment 126 is connected to the upper main body 108, in particular via the first upper adjustment mechanism 112. The second segment 128 is connected to the upper joint device 106-1, 106-2. The third segment 130 is arranged between the first and second segments 126, 128 and is connected both to the first segment 126 and to the second segment 128 via a pivot connection 132. By way of example, the second upper adjustment mechanism 114 is designed such that the first segment 126 and the second segment 128 are always aligned in parallel with each other.

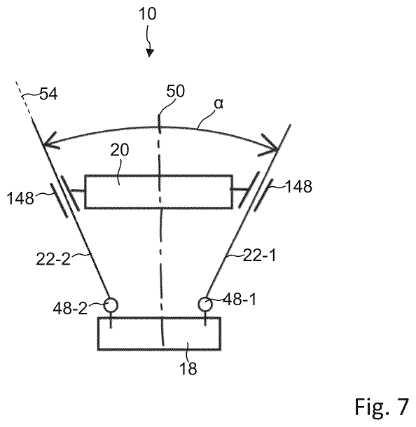

An advantageous effect of the aid 10 can result from a combination of an articulated linking of the supports 22-1, 22-2 with the upper body linking means 20 and the above-described adjustability of the upper body linking means 20. As shown schematically in FIG. 7, by changing a distance between the upper connection points 32-1, 32-2 in combination with the upper joint devices 106-1, 106-2, an inclination angle α of the supports 22-1, 22-2 relative to the median plane 50 can be adjusted and thus the aid 10 can be flexibly adapted to different body anatomies.

1. Wearable aid for supporting in the raising and/or holding of loads by an operator, comprising
a supporting structure having a first support and a second support, wherein the first support and the second support each have a rear section and a cantilever-type section, in such a way that, when the aid is worn by the operator, the back section is arranged posteriorly and extends substantially along the back section of the operator and the cantilever-type section extends posteriorly to anteriorly;
a lower body linking means for coupling the supporting structure to a pelvic, hip or lumbar area of the operator;
an upper body linking means for coupling the supporting structure to an upper body of the operator, in particular to a back, shoulder and/or chest region;
a first hand linking means for linking to a right hand or underarm region of the operator, wherein the first hand linking means is connected to the first support via a first length-adjustable connecting device;
a second hand linking means for linking to a left hand or underarm region of the operator, wherein the second hand linking means is connected to the second support via a second length-adjustable connecting device,
wherein the first support is connected to the upper body linking means at a first upper connection point via a first upper joint device and wherein the second support is connected to the upper body linking means at a second upper connection point via a second upper joint device.

2. Wearable aid according to claim 1, wherein the first upper joint device and the second upper joint device each have at least two, preferably three, degrees of joint freedom.

3. Wearable aid according to claim 1, wherein the first upper joint device and the second upper joint device each comprise:
a. a first degree of pivoting freedom about a first pivot axis which is orthogonal to the median plane, in particular when the aid is worn;
b. a second degree of pivoting freedom about a second pivot axis orthogonal to the first pivot axis, in particular orthogonal to the frontal plane when the aid is worn;
c. a translational degree of freedom along a longitudinal axis of the support, in particular along a longitudinal axis of the back section of the support.

4. Wearable aid according to claim 3, wherein the first degree of pivoting freedom is provided by a first pivot joint connected to the upper body linking means, and wherein the second degree of pivoting freedom is provided by a second pivot joint connected to the first pivot joint.

5. Wearable aid according to claim 3, wherein the translational degree of freedom is provided by a displacement sleeve in which the support is axially displaceably received.

6. Wearable aid according to claim 5, wherein the displacement sleeve is designed such that the support can be pivoted about its longitudinal axis.

7. Wearable aid according to claim 1, wherein the upper body linking means comprises an upper force distribution means connected to the supports, in particular via the upper joint devices, and wherein the upper body linking means comprises a flexible upper body linking means device connected to the upper force distribution means for attachment to an upper body region of the operator.

8. Wearable aid according to claim 7, wherein the upper body linking means device comprises at least one textile part, further in particular in the form of a belt, belt system or a cuff.

9. Wearable aid according to claim 7, wherein the upper force distribution means comprises an upper main body which extends between the first support and the second support and on which the upper joint devices are arranged.

10. Wearable aid according to claim 9, wherein the upper force distribution means has a force introduction plate which is connected to the upper body linking means device on one side and to the upper main body on the other side in such a way that a distance of the force introduction plate from the upper main body and/or a position of the force introduction plate can be changed cranially and caudally, in particular can be adjusted.

11. Wearable aid according to claim 1, wherein the upper body linking means is designed such that a relative position of the first upper connection point and the second upper connection point can be changed, in particular a position of the first upper connection point and/or of the second upper connection point can be changed, in particular adjusted, in particular independently of one another, laterally and medially relative to the median plane and/or in the anterior direction and in the posterior direction relative to the frontal plane when the aid is worn.

12. Wearable aid according to claim 1, wherein the first support is connected to the lower body linking means at a first lower connection point, in particular in an articulated manner, further in particular via a first lower joint device, and wherein the second support is connected to the lower body linking means at a second lower connection point, in particular in an articulated manner, further in particular via a second lower joint device.

13. Wearable aid according to claim 1, wherein a securing means is provided for securing the first and second upper joint devices, in particular wherein a securing means is also provided for securing the first and second lower joint devices.

14. Wearable aid according to claim 1, wherein the first support and the second support are each connected to the lower body linking means via a ball joint and wherein the first upper joint device and the second upper joint device each have at least two, preferably at least three, degrees of joint freedom.

15. Wearable aid according to claim 12, wherein the lower body linking means is designed in such a way that a relative position of the first lower connection point and the second lower connection point can be changed, in particular a position of the first lower connection point and/or of the second lower connection point can be changed, further in particular adjusted, in particular independently of one another, laterally or medially relative to the median plane and/or in the anterior direction or in the posterior direction relative to the frontal plane when the aid is worn.
